(19) United States
(12) Patent Application Publication
(10) Pub. No.: US 2003/0145133 A1
(43) Pub. Date: Jul. 31, 2003

(54) SCSI - handling of I/O scans to multiple LUNs during write/read command disconnects

(76) Inventors: Simon Pelly, Bristol (GB); Neil Johnson, Bristol (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/060,080

(22) Filed: Jan. 31, 2002

(51) Int. Cl. G06F 3/00

(52) U.S. Cl. 710/1

(57) ABSTRACT

There is disclosed a method of handling of I/O scans to multiple logical unit numbers used to identify individual peripheral devices on a small computer system interface, wherein a peripheral device, upon receiving an inquiry command, checks whether a write/read I/O command is outstanding, if a write/read I/O command is outstanding, sets a delay flag delaying said peripheral device for a predetermined period of time; on expiry of said delay time, initiates a data transfer with the host device.

### FIELD OF THE INVENTION

The present invention relates to the field of computers and particularly, although not exclusively to a small computer system interface (SCSI) connection between two or more computer entities.

### BACKGROUND TO THE INVENTION

The small computer system interface (SCSI) is well known to those in the art of computer science and comprises a protocol for allowing communication between a plurality of computer entities, for example a host computer and one or more peripheral devices. There are many types of host computer device known in the art and also many types of peripheral devices known in the art which can communicate with each other via the known SCSI interface.

The specification for SCSI can be obtained from American National Standards Institute, 1430 Broadway, N.Y. 10018. The SCSI specification (ANSI Standard X3.131-1986) defines a high performance peripheral interface which distributes data among peripherals independently of a host computer, thereby freeing a host computer for more user oriented activities.

Referring to FIG. 1 herein, there is illustrated schematically a typical SCSI arrangement in which a host computer 100 connected via a SCSI bus to a plurality of tape drive data storage devices 101-103.

Referring to FIG. 2 herein, there is illustrated schematically a logical diagram of the arrangement of FIG. 1. Host computer 200 communicates with a plurality of tape drive data storage back-up devices 201-203 via a SCSI bus 204.

Each device has a SCSI driver. Host computer 200 has a host driver, whereas each peripheral device 201-203 has a peripheral device SCSI driver.

In the particular example of a Hewlett Packard UX type host device, communicating with a tape drive data storage back-up peripheral, via a SCSI interface, there has been experienced the particular problem that hangs of the SCSI interface may occur, even when the behavior of two or more tape drive units 201-203 and the host computer is perfectly legal, i.e. within the SCSI specification.

In the context of data back-up, having hangs of a SCSI interface bus between a host computer and a peripheral back up data storage device can cause failure of back up of data and is therefore to be avoided if possible.

Specific implementations according to the present invention have arisen from the need to identify the cause of the hangs on the SCSI interface and to implement a solution to those hangs.

### SUMMARY OF THE INVENTION

Where a SCSI peripheral device is writing or reading after an SCSI command phase originating from a SCSI host computer device, the peripheral device may disconnect from the SCSI bus. The SCSI bus is then deemed free for the host computer to issue further SCSI inquiry commands to peripherals on the bus, to determine which peripheral devices are connected to the bus. This I/O scan process takes a relatively long period of time, relative to the SCSI command phase, bus free period and response from the peripheral device to the SCSI command phase.

In a best mode implementation of the invention, a peripheral device allows a relatively long period of time for the I/O scan process to interrogate each peripheral device on the bus. The time out delay allowed by the peripheral is long enough for the host computer to determine which devices are connected on the SCSI bus.

According to a best mode implementation, there is provided a method of operating a SCSI enabled computer peripheral device wherein the peripheral device waits a period of time if it detects that an I/O scan has been issued after a write/read command has disconnected.

This may have the advantage of avoiding a prior art problem wherein a peripheral device is legally allowed within the SCSI protocol to re-select a host computer during and I/O scan period i.e. when bus free, and to continue with a read/write data phase. In some prior art operating systems and SCSI drivers, to continue a write/read data phase during an I/O scan period causes prior art systems to crash. Specific implementations according to the present invention may have an advantage of avoiding such crashes.

According to a first aspect of the present invention, there is provided a method of operating a peripheral device enabled to communicate using a small computer system interface protocol, said method comprising:

receiving a SCSI command write/read signal;

receiving a SCSI inquiry signal;

in response to receipt of said received SCSI command write/read signal and said received SCSI inquiry signal, causing said peripheral device to delay initiating a response to the SCSI inquiry signal for a predetermined time period.

According to a second aspect of the present invention there is provided a tape data storage device comprising:

a tape drive mechanism for accepting a removable tape data storage media for storage of data;

at least one buffer memory for temporarily storing data to be read to said tape data storage media and to be written from said tape data storage media;

a small computer system interface driver;

a controller device for controlling said buffer memory, said tape drive mechanism and said small computer system interface driver;

wherein said tape data storage device operates to:

receive a SCSI command write/read signal;

receive a SCSI inquiry signal;

in response to receipt of said received SCSI command write/read signal and said received SCSI inquiry signal, cause said peripheral device to delay initiating a response to the SCSI inquiry signal for a predetermined time period.

According to a third aspect of the present invention, there is provided a driver for operating a small computer system interface enabled peripheral device enabled to communicate with at least one other SCSI enabled device according to the SCSI protocol, said driver comprising:

means for receiving a SCSI command write/read signal;

means for receiving a SCSI inquiry signal; and

a delay timer;

wherein in response to receipt of said received SCSI command write/read signal and said received SCSI inquiry signal, said driver causes said peripheral device to delay initiating a response to the SCSI inquiry signal for a predetermined time period.

According to a fourth aspect of the present invention, there is provided a system of computer entities, communicating via a small computer system interface, said system comprising:

at least one host computer entity;

at least one target computer entity;

said system operating such that:

arbitration is initiated by the target entity, to select the host computer and commencement of data transfer between the host computer and target entity can occur during a bus free period comprising the inquiry period of an inquiry initiated by said host computer to said target entity.

According to a fifth aspect of the present invention, there is provided a program data comprising program instructions for causing a processor to operate a small computer system interface (SCSI) protocol driver, said driver operating to:

receive a SCSI command write/read signal;

receive an SCSI inquiry signal;

in response to receipt of said received SCSI command write/read signal and said received SCSI inquiry signal, set a delay timer to extend for a predetermined time period; and

on expiry of said time period, respond to said SCSI inquiry.

The invention includes a driver for operating a small computer system interface enabled peripheral device enabled to communicate with at least one other SCSI enabled device according to the SCSI protocol, said driver operable to:

receive SCSI command write/read signal;

receive a SCSI inquiry signal; and

a delay timer;

wherein in response to receipt of said received SCSI command write/read signal and said received SCSI inquiry signal, said driver operates to cause said peripheral device to delay initiating a response to said SCSI inquiry signal for a predetermined time period.

Other aspects of the invention are as recited in the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically the general arrangement of a host computer connected to a peripheral tape data storage device via a SCSI bus as is known in the prior art;

FIG. 2 illustrates schematically a logical view of the arrangement of FIG. 1 illustrating a host computer device and a plurality of peripheral computer devices connected to a SCSI bus as is known in the prior art;

FIG. 3 illustrates schematically a sequence of messages according to the SCSI protocol between a SCSI host computer and at least one SCSI peripheral device;

FIG. 4 illustrates schematically a second message sequence initiated by a host device for sending an inquiry command to a peripheral device;

FIG. 5 illustrates schematically components of a tape data storage device, having a SCSI interface and controller according to a specific implementation of the present invention;

FIG. 6 illustrates schematically a state diagram and process steps operated by the tape data storage device in FIG. 5 for implementing a specific process according to the present invention; and

FIGS. 7-9 illustrates schematically states and processes according to the specific implementation of the invention, operated by a tape data storage device for avoiding a hang of an SCSI interface of the tape data storage device.

### DETAILED DESCRIPTION OF THE BEST MODE FOR CARRYING OUT THE INVENTION

There will now be described by way of example the best mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

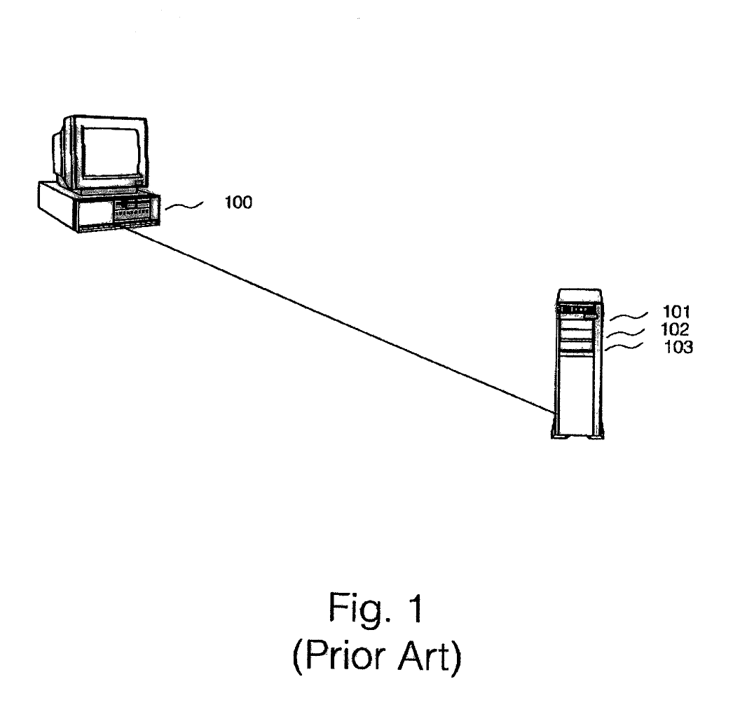

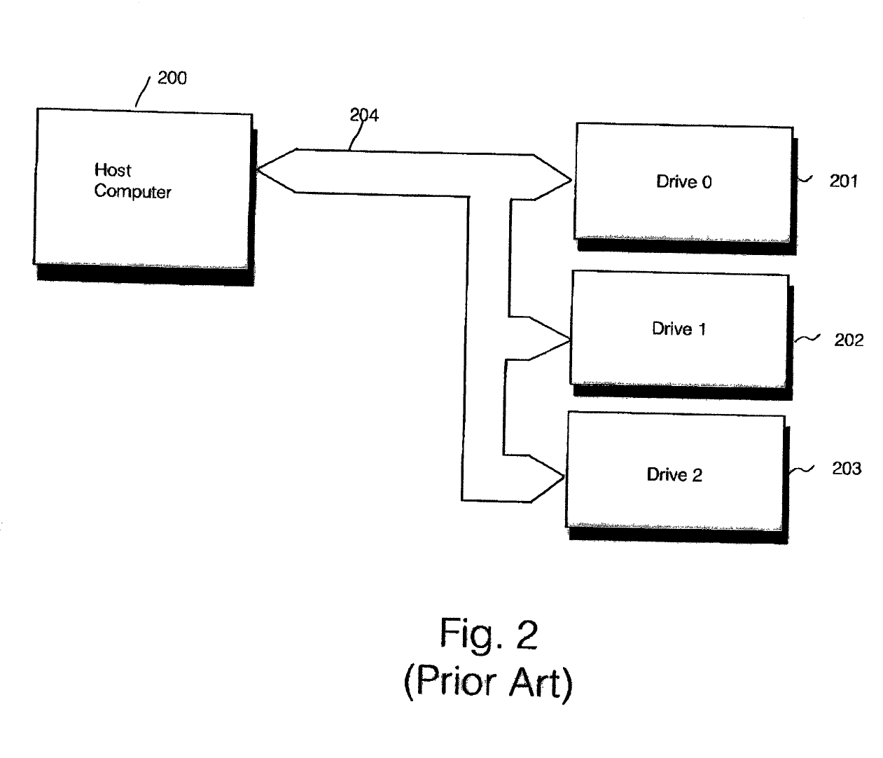

In the following description, a problem with the prior art host computer and host SCSI driver and prior art peripheral device and peripheral driver in a tape data storage back up device of FIGS. 1 and 2 is described.

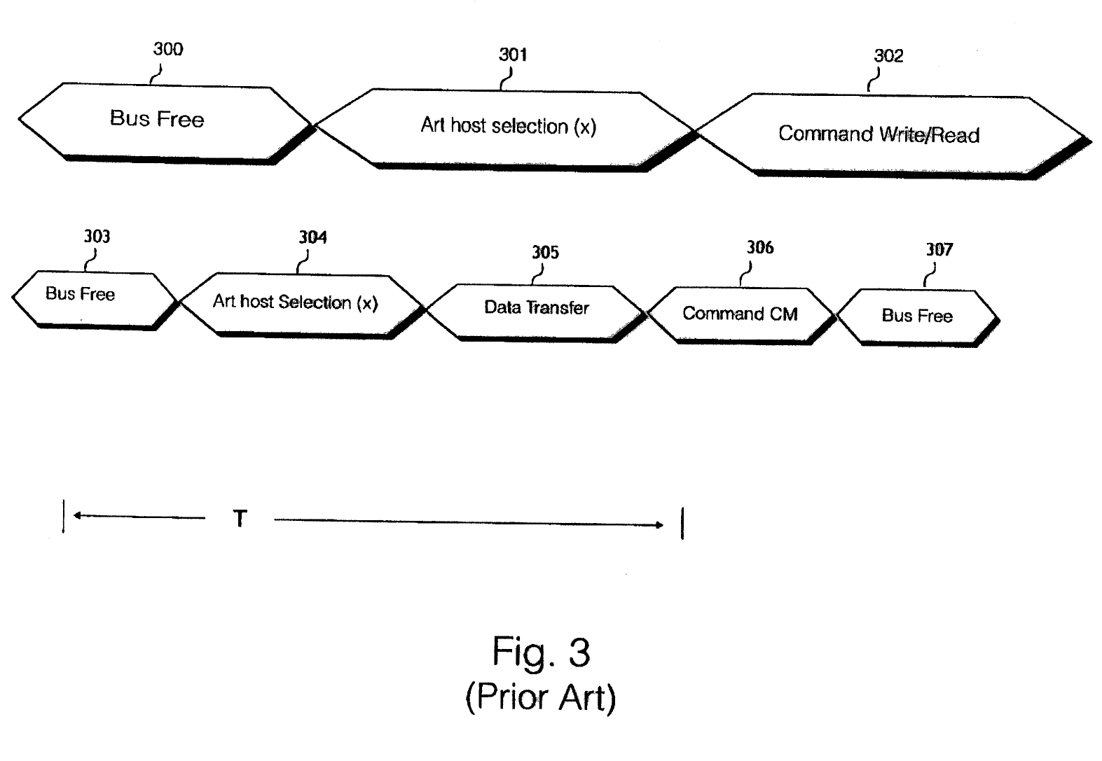

Referring to FIG. 3 herein, there is illustrated schematically a sequence of messages according to the SCSI protocol, between an SCSI host computer 201 and a plurality of SCSI peripheral devices 201-203 attached to the SCSI bus. A host driver at the host computer sends inquiry commands to each driver connected to the bus. Each driver connected to the bus has its own unique identification number (LUN) which in this case, are number 0 to 15. An I/O scan process sends inquiry commands to each peripheral device in turn. Some drivers may not exist on the LUN addresses. However, for those drivers which do exist, the drivers of those peripheral devices send back data identifying the type of peripheral device in each case.

In the case of a host computer communicating with one or more peripheral tape data storage devices (tape drives) the I/O process can occur at any point in time and therefore could clash with a period when the host computer is performing a data back-up operation to one or more of the tape data storage peripheral devices, or could clash with a period when the host computer is restoring data from one of the tape data storage peripheral devices. Therefore, when inquiry commands are being issued, they may be inter-leaved on the SCSI bus with read commands from the peripheral devices to the host or from the host to a tape data storage device.

A bus free interval 300 occurs when there are no transactions on the bus. After the bus free interval, there occurs an arbitration host selection period 301, where the host computer communicates on the bus, in order to select a particular peripheral device. The arbitration process according to the SCSI protocol, is a process whereby a single device can seize control of the bus and select another device connected to the bus, with which to communicate. Once a peripheral device is selected, there follows a command phase 302, where either a write command or a read command is issued by the host computer.

The selected peripheral device, in response to the command write/read, needs to set up internal buffers and prepare data to be communicated with the host. There occurs a disconnect of the peripheral device from the bus, whilst the selected drive prepares itself to communicate with the host computer. Hence, a second bus free period 303 occurs. After the second bus free period, which can have an arbitrary time, the peripheral device seizes the SCSI bus and selects the host computer in the second arbitrary host selection period 304. This is followed by a data transfer period 305, in which data is transferred between the host computer and the peripheral device. In the case of a write command, data is transferred from the host computer to the peripheral device. In the case of a read command, data is read from the peripheral tape data storage device back to the host computer.

Following the data transfer, there is a command complete phase 306, following which the SCSI bus is released by the tape drive and the SCSI bus enters a third bus free period 307.

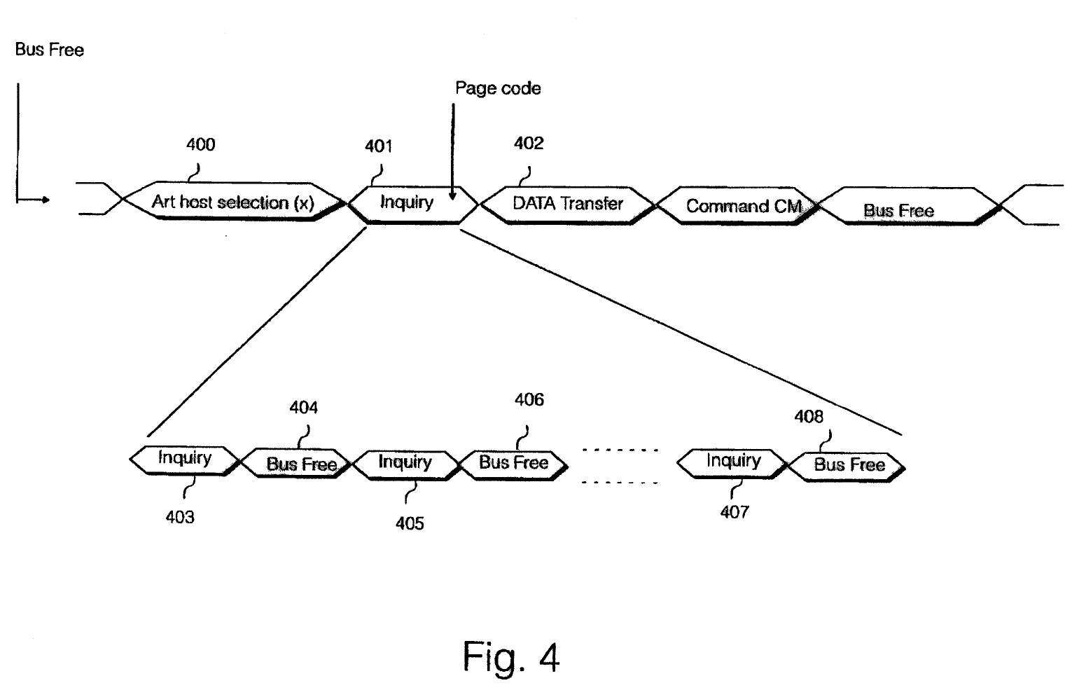

Referring to FIG. 4 herein, there is illustrated schematically a sequence of SCSI signals which can occur causing a problem in the prior art SCSI enabled peripheral tape data storage device in crashing or hanging the SCSI bus.

During the second bus free period 303 after the command read/write period 302, before the tape drive is ready to communicate again with the host computer, a problem occurs in that it is possible that the host computer seizes the bus, enters a second host initiated arbitration process 400 for selecting a drive, selects the same drive as previously selected and issues an inquiry command 401.

According to the SCSI protocol, following an inquiry command, there is never a disconnect but always a data transfer 402 where data is immediately sent back from the peripheral device to the host.

There may be multiple inquiry commands made by the host computer to the same peripheral device. Part of the inquiry command 401 comprises a particular page code embedded within the inquiry command. Therefore, there may be multiple enquiry commands 403-405 going back to the host computer with bus free periods 406-408 between each of these inquiry commands.

What has been observed is that, because the inquiry period may occupy a relatively long time period relative to the time period T1 shown in FIG. 3, in which the tape drive unit arbitrates on the SCSI bus to select the host and then transfers data between the host computer and the tape drive, that arbitration process 304 and data transfer process 305 may need to occur during the inquiry period 401, without waiting for the end of the inquiry period 401.

Typically the whole input/output process will be over in a matter of milliseconds. This is a relatively long time compared to the second bus free period 303, in which the host computer waits for the tape drive unit to arbitrate back for selection of the host computer in second arbitration host selection period 304. Therefore, there is a conflict between the selected tape drive wishing to arbitrate back to the host computer and the host computer initiating a new arbitration to select the same tape drive. Practically, this means that under these conditions, the selected tape drive cannot arbitrate back to the host computer because it is blocked by the host computer having issued an inquiry to the selected tape drive, which can cause a crash in the tape drive.

One solution would be to replace the host driver, with a new driver which does not arbitrate to a peripheral, immediately after an arbitration host selection process and command write/read phase. However, in practice there are a large number of legacy host drivers in existence and replacing all these host drivers with modified host drivers is not practical. Therefore, a modification of the peripheral device is preferred.

The inventors have realized that a solution to these problems may utilize the bus free periods within the inquiry period 401. During these bus free periods, it is legal within the SCSI specification, for the tape drive unit to arbitrate back to select the host computer, in order to respond to the original command write/read 302. Therefore, arbitration initiated by the peripheral tape drive, to select the host computer, and commencement of data transfer between the host computer and the tape drive can occur during a bus free period comprising the inquiry period 401 of an inquiry initiated by the host computer to the tape drive, where the inquiry occurs after the host computer has issued a command write/read to the tape drive but before the tape drive has had sufficient time to respond to the command write/read.

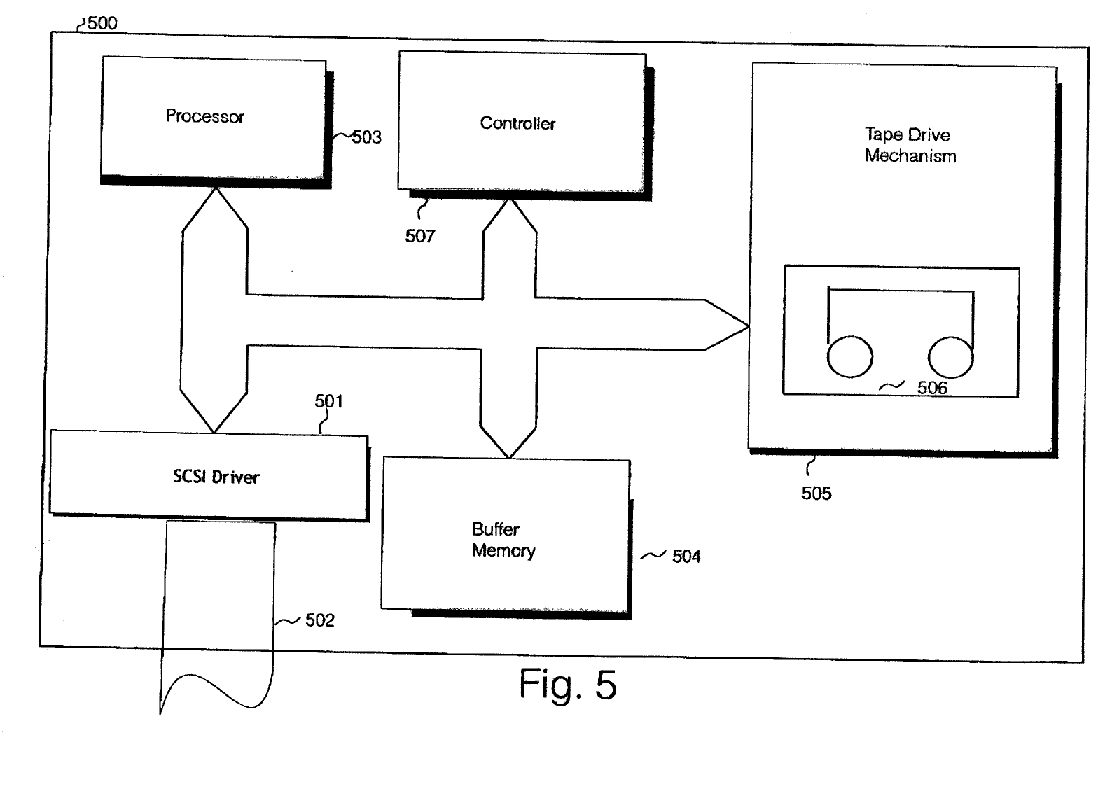

Referring to FIG. 5 herein there is illustrated schematically components of a tape data storage device according to a best mode implementation of the present invention. The tape data storage device 500 comprises a SCSI interface 501 capable of communicating with a SCSI bus 502; at least one data processor 503; a buffer memory 504; a tape drive mechanism 505 having a port for accepting a removable tape data storage medium 506; a controller 507 for controlling input of data through the SCSI interface 501 and for controlling and managing data storage in the buffer memory 504 and for controlling data storage and management in the tape drive mechanism 505. The tape data storage device also comprises power supply, liquid crystal display for showing an operational status of the data storage device as is known in the prior art.

Within the controller 507 is a flash EEPROM which store an algorithm in the form of stored program data for operating the tape drive mechanism, buffer memory, processor 503 and SCSI interface 501. Controller 507 contains program data written in the conventional program language for example C, or C++ as is known to those skilled in the art. The program data comprises an algorithm for causing the SCSI enabled peripheral device to operate in modes of operation as follows.

There will now be described operation of a tape data storage device for overcoming the problem of hangs caused under conditions in which a host 15 computer device seizes a SCSI bus during a bus free period after an arbitration host selection period and command write/read period.

In the best mode implementation, a peripheral SCSI driver operates to detect conditions wherein a command from a host driver is outstanding and that an I/O scan is in progress and to delay data transfer either in or out to the host for the overlapped command. The I/O scan has a maximum time period which it can take, therefore the peripheral driver according to the best mode implementation waits until that I/O scan has finished and then to continues with the data transfer from the write/read command.

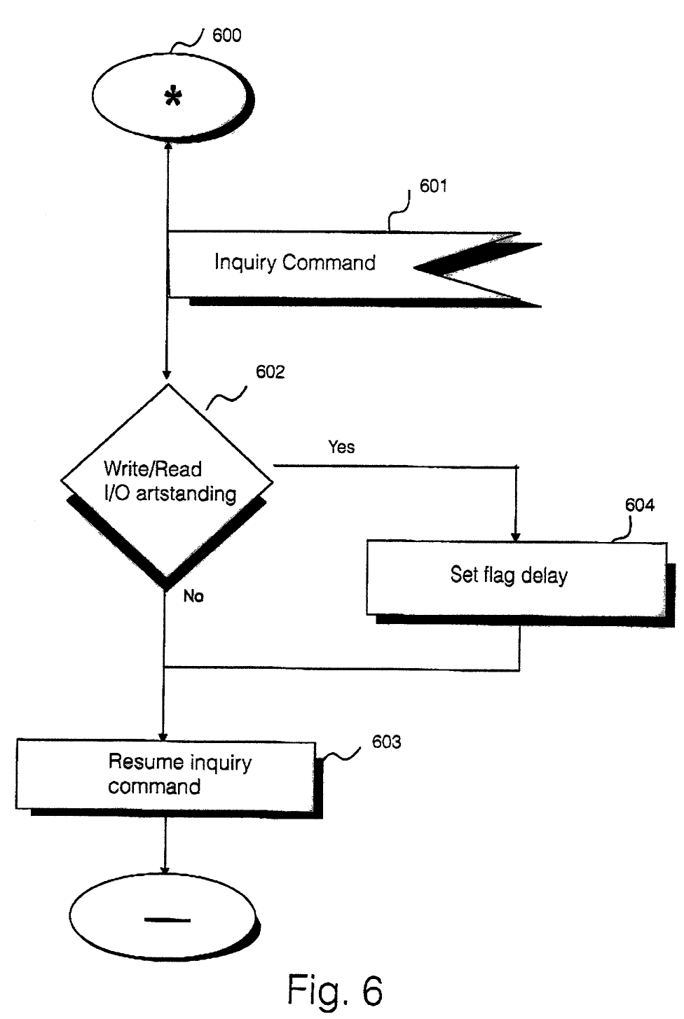

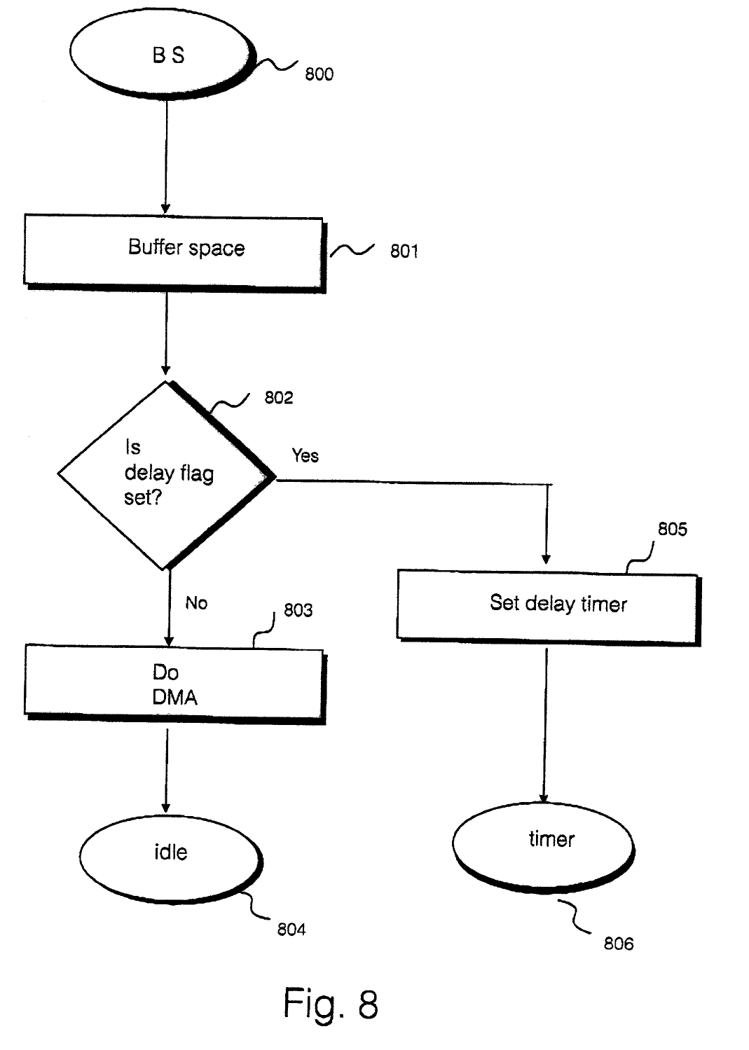

Referring to FIGS. 6-9 herein, there is illustrated schematically an algorithm for operation of a SCSI driver of a peripheral device. In FIGS. 6-9 ellipses represent states of the peripheral SCSI driver; indented boxes represent inputs to those states; and quadrilateral boxes represent process steps carried out by the peripheral SCSI driver.

Referring to FIG. 6 herein, in an initial state 600 which can be any state of the SCSI driver, the driver awaits input of an inquiry command 601 from a host computer. On receiving an input inquiry command 601, the peripheral driver determines in process 602, whether a write I/O operation is outstanding and/or whether a read I/O operation is outstanding. If there is no I/O operation outstanding, then in process 603 the peripheral driver resumes the inquiry command and returns to the initial state 604 which the driver was in before the inquiry command 601 was detected.

However, if the peripheral driver is in a particular state 600 and receives an inquiry command 601 from a host computer and in process 602 it is determined that a write I/O is outstanding, then in process 604, a delay flag is set, activating a delay timer. The peripheral driver then proceeds in process 603 to carry out the inquiry command. The inquiry command is always executed irrespective of whether there is a write I/O operation outstanding or not, or whether there is a read I/O operation outstanding or not. However, if an I/O operation is outstanding, the execution of the inquiry command by the peripheral is delayed until the data transfer between the host and the peripheral is completed.

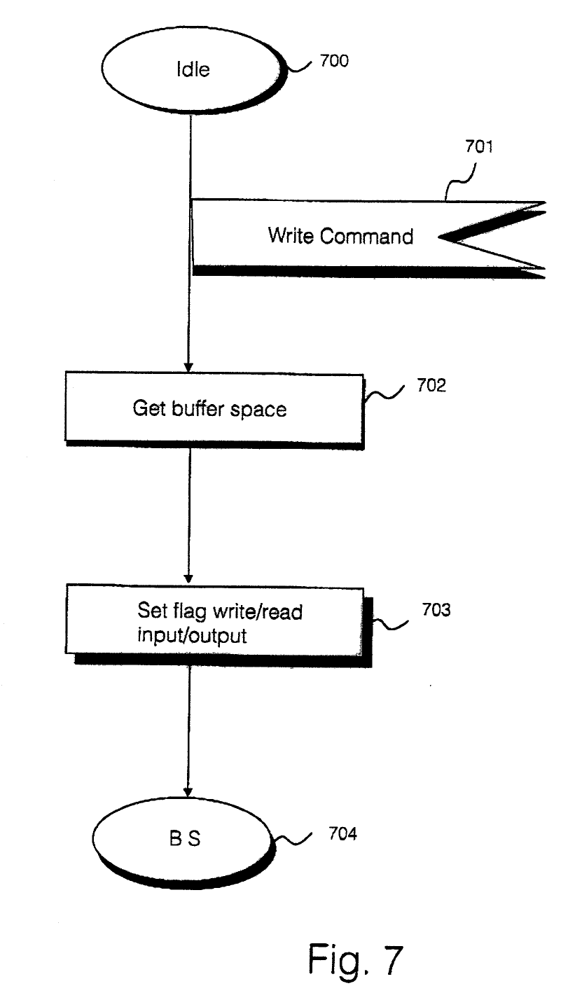

Referring to FIG. 7 herein, if the peripheral driver is in an idle state 700, and is asked to perform a write command, by receiving write command 701 from a host computer, then in process 702 the tape data storage device needs to secure a predetermined quantity of buffer space, that is, to reserve a predetermined amount of data storage capacity in buffer memory 504 of the tape data storage device in process 702. This reserve memory capacity is required to store data which will be sent from the host device to the peripheral device. Once a write command is received from the host, the peripheral device sets a read/write input/output flag. In process 703, there is set a flag indicating that a write I/O operation or read I/O is in progress which is followed by the peripheral driver entering a buffer space allocation state 704. At this stage, the driver transfers into a further state 704, waiting for buffer memory space to be allocated.

Once buffer memory space is allocated, then a buffer space available signal is generated. When buffer space is available, then the algorithm determines the status of the delay flag. If the delay flag indicates that the peripheral SCSI interface should not delay any operations, then a direct memory access (DMA) data transfer from the host to the peripheral tape data storage device occurs, writing data from a host buffer memory to the peripheral buffer memory 504 in process 803. The peripheral then reverts to idle state 804. If in process 802, when the delay flag is checked, a delay timer is set in process 805, this causes the peripheral driver to enter a timer state 806.

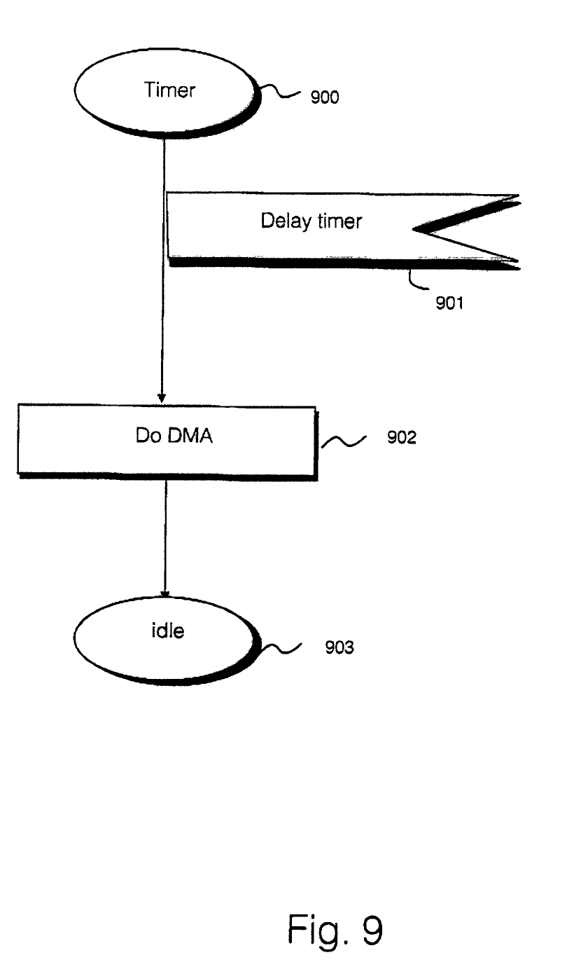

Referring to FIG. 9 herein, when timer state 900 expires, resulting in a delay timer off signal 901, the peripheral driver reverts to a direct memory access operation 902 resulting in a data transfer and then the peripheral device reverts to an idle state.

It will be appreciated by those skilled in the art, that the peripheral driver as described herein above can be provided as a computer program data download which is input into a prior art tape data storage device having a SCSI interface, as a modification or upgrade to that tape data storage device.

Alternatively, the program data implementing the above process may be stored on a data storage carrier, for example a CD-ROM or floppy disk, or may be downloaded to a tape data storage device as program data from a host computer. The host computer may obtain the peripheral driver electronically, for example over the internet, as an electronic download of data, or may acquire the program data for creating the peripheral driver by reading a CD-ROM or other program data storage carrier.

1. A method of operating a peripheral device enabled to communicate using a small computer system interface protocol, said method comprising:
receiving a SCSI command write/read signal;
receiving a SCSI inquiry signal;
in response to receipt of said received SCSI command write/read signal and said received SCSI inquiry signal, causing said peripheral device to delay initiating a response to the SCSI inquiry signal for a predetermined time period.

2. The method as claimed in claim 1, further comprising:
setting a delay timer and entering a delay mode for delaying said peripheral device initiating a response to said SCSI inquiry signal said delay mode set to extend for said pre-determined time period.

3. The method as claimed in claim 1, further comprising:
upon expiry of said pre-determined time period, responding to said SCSI command write/read signal by performing an arbitrary host selection procedure and performing a data transfer procedure.

4. A tape data storage device comprising:
a tape drive mechanism for accepting a removable tape data storage media for storage of data;
at least one buffer memory for temporarily storing data to be read to said tape data storage media and to be written from said tape data storage media;
a small computer system interface driver;
a controller device for controlling said buffer memory, said tape drive mechanism and said small computer system interface driver;
wherein said tape data storage device operates to:
receive a SCSI command write/read signal;
receive a SCSI inquiry signal;
in response to receipt of said received SCSI command write/read signal and said received SCSI inquiry signal, cause said peripheral device to delay initiating a response to the SCSI inquiry signal for a predetermined time period.

5. The tape data storage device as claimed in claim 4, further operating to:
set a timer and enter a delay mode, said delay mode which delays said data storage device initiating a response to said SCSI inquiry signal set to extend for a pre-determined time period.

6. The tape data storage device as claimed in claim 4, further operable to:
upon expiry of said pre-determined delay time period, respond to said SCSI command write/read signal by performing an arbitrary host selection procedure and performing a data transfer procedure.

7. A driver for operating a small computer system interface enabled peripheral device enabled to communicate with at least one other SCSI enabled device according to the SCSI protocol, said driver comprising:
means for receiving a SCSI command write/read signal;
means for receiving a SCSI inquiry signal; and
a delay timer;
wherein in response to receipt of said received SCSI command write/read signal and said received SCSI inquiry signal, said driver causes said peripheral device to delay initiating a response to the SCSI inquiry signal for a predetermined time period.

8. The driver as claimed in claim 7, wherein said driver operates to set a delay timer and enter a delay mode, said delay mode set to extend for said predetermined time period.

9. The driver as claimed in claim 7, wherein when in said delay mode, said driver delays sending a response to said SCSI inquiry signal.

10. The driver as claimed in claim 7 which operates such that:
upon expiry of said predetermined delay time period, said driver responds to said SCSI command write/read signal by performing an arbitrary host selection procedure and performing a data transfer procedure.

11. A system of computer entities, communicating via a small computer system interface, said system comprising:
at least one host computer entity;
at least one target computer entity;
said system operating such that:
arbitration is initiated by the target entity, to select the host computer and commencement of data transfer between the host computer and target entity can occur during a bus free period comprising the inquiry period of an inquiry initiated by said host computer to said target entity.

12. Program data comprising program instructions for causing a processor to operate a small computer system interface (SCSI) protocol driver, said driver operating to:
receive a SCSI command write/read signal;
receive an SCSI enquiry signal;
in response to receipt of said received SCSI command write/read signal and said received SCSI inquiry signal, set a delay timer to extend for a predetermined time period; and
on expiry of said time period, respond to said SCSI enquiry.

13. A driver for operating a small computer system interface enabled peripheral device enabled to communicate with at least one other SCSI enabled device according to the SCSI protocol, said driver operable to:
receive SCSI command write/read signal;
receive a SCSI inquiry signal; and
a delay timer;
wherein in response to receipt of said received SCSI command write/read signal and said received SCSI inquiry signal, said driver operates to cause said peripheral device to delay initiating a response to said SCSI inquiry signal for a predetermined time period.
